(19) United States
(12) Patent Application Publication
(10) Pub. No.: US 2025/0286327 A1
(43) Pub. Date: Sep. 11, 2025

(54) CABLE CONNECTOR ASSEMBLY HAVING CONNECTOR IDENTIFICATION MODULE

(71) Applicant: TE Connectivity Solutions GmbH, Schaffhausen (CH)

(72) Inventors: Albert Tsang, Middletown, PA (US); Julia Anne Lachman, Middletown, PA (US); David Allison Trout, Middletown, PA (US); Linda Ellen Shields, Middletown, PA (US); Jazmine Hancock, Middletown, PA (US)

(21) Appl. No.: 19/051,267

(22) Filed: Feb. 12, 2025

Related U.S. Application Data
(60) Provisional application No. 63/563,511, filed on Mar. 11, 2024.

(51) Int. Cl. H01R 13/66

(52) U.S. Cl. CPC H01R 13/6691

(57) ABSTRACT

A cable connector assembly includes a cable connector including a connector housing holding contact assemblies with cables terminated to signal contacts and shields. The cable connector assembly includes a connector identification module configured to be mated with a mating connector assembly. The connector identification module includes an identification contact assembly received in the cavity and coupled to the connector housing. The identification contact assembly includes an identification contact holder holding an identification signal contact. The connector identification module includes an identification device having unique identification data stored on the identification device. The identification device is operably coupled to the identification signal contact to transmit the unique identification data to the mating connector assembly.

### CROSS REFERENCE TO RELATED APPLICATIONS

This application claims benefit to U.S. Provisional Application No. 63/563,511, filed 11 Mar. 2024, titled “CABLE CONNECTOR ASSEMBLY HAVING CONNECTOR IDENTIFICATION MODULE”, the subject matter of which is herein incorporated by reference in its entirety.

### BACKGROUND OF THE INVENTION

The subject matter herein relates generally to communication systems.

Cable assemblies are used to electrically connect various components within a system, such as a server or network system. The cable assemblies extend between the components, such as network, compute, storage, memory, or other components. The components may be arranged in shelves or trays of a network rack. Some systems may include components such as cards, such as line cards, daughter cards, mother boards, and the like. Each cable assembly includes multiple cables arranged in a bundle or array. Each cable forms a data channel. As the density of cable assemblies in the network system increase, it is desirable to know the locations of the components within the system, such as for service, repair or replacement.

A need remains for a method and device for identifying components and locations of components within a network system.

### BRIEF DESCRIPTION OF THE INVENTION

In one embodiment, a cable connector assembly is provided and includes a cable connector including a connector housing having walls to define a cavity. The cable connector includes contact assemblies received in the cavity. Each contact assembly includes a contact holder holding a signal contact and a shield providing shielding for the signal contact. The signal contacts and the shields of the contact assemblies arranged at a mating end of the cable connector configured to be mated with a mating connector assembly. The cable connector assembly includes cables terminated to the signal contacts and extend from a cable end of the cable connector. The cables define data channels. The cable connector assembly includes a connector identification module configured to be mated with the mating connector assembly. The connector identification module includes an identification contact assembly received in the cavity and coupled to the connector housing. The identification contact assembly includes an identification contact holder holding an identification signal contact arranged at the mating end of the cable connector configured to be mated with the mating connector assembly. The connector identification module includes an identification device having unique identification data stored on the identification device. The identification device is operably coupled to the identification signal contact to transmit the unique identification data to the mating connector assembly.

In another embodiment, a connector identification module is provided and includes an identification contact assembly including an identification contact holder extending between a front and a rear. The identification contact assembly includes an identification signal contact held by the identification contact holder. The identification signal contact includes a mating end and a terminating end. The mating end configured to be mated with a mating connector assembly. The cable connector assembly includes an identification cable extending between a first end and a second end. The first end terminated to the identification signal contact. The cable connector assembly includes an identification device having a printed circuit board assembly that includes a printed circuit board and an electronic device mounted to the printed circuit. The electronic device has unique identification data stored on the electronic device. The printed circuit board is terminated to the second end of the identification cable. The cable defines a data channel between the printed circuit board and the identification signal contact to transmit the unique identification data to the mating connector assembly.

In a further embodiment, a communication system is provided and includes a cartridge having panels forming a chamber. The cartridge includes ports at a front of the cartridge. The communication system includes cable connector assemblies received in the ports for mating with mating connector assemblies. Each cable connector assembly includes a cable connector and a connector identification module communicatively coupled to the cable connector by cables. Each cable connector includes a connector housing having walls define a cavity. The cable connector includes contact assemblies received in the cavity. Each contact assembly includes a contact holder holding a signal contact and a shield providing shielding for the signal contact. The signal contacts and the shields of the contact assemblies arranged at a mating end of the cable connector configured to be mated with the mating connector assembly. The cables are terminated to the signal contacts and extend from a cable end of the cable connector. The cables define data channels. The connector identification module includes an identification contact assembly received in the cavity and coupled to the connector housing. The identification contact assembly includes an identification contact holder holding an identification signal contacts arranged at the mating end of the cable connector configured to be mated with the mating connector assembly. The connector identification module includes an identification device having unique identification data stored on the identification device. The identification device is operably coupled to the identification signal contacts to transmit the unique identification data to the mating connector assembly.

### BRIEF DESCRIPTION OF THE DRAWINGS

FIG. 1 is a front view of a communication system in accordance with an exemplary embodiment.

FIG. 2 is a front view of a portion of the communication system in accordance with an exemplary embodiment.

FIG. 3 illustrates a portion of the communication system showing two of the cartridges in accordance with an exemplary embodiment.

FIG. 4 is a perspective view of a portion of the communication system showing one of the mating connector assemblies poised for coupling to the corresponding connector assembly in accordance with an exemplary embodiment.

FIG. 5 is a front perspective view of a portion of the communication system\showing one of the connector assemblies\in accordance with an exemplary embodiment.

FIG. 6 is an exploded view of one of the contact assemblies in accordance with an exemplary embodiment.

FIG. 7 is a side view of one of the contact modules in accordance with an exemplary embodiment.

FIG. 8 is a side view of a portion of the connector identification module showing an identification contact module in accordance with an exemplary embodiment.

FIG. 9 is a side view of a portion of the connector identification module showing the identification device in accordance with an exemplary embodiment.

FIG. 10 illustrates one of the connector assemblies in accordance with an exemplary embodiment having the connector identification module.

FIG. 11 illustrates a portion of the communication system showing a plurality of the connector assemblies in accordance with an exemplary embodiment arranged in the cartridge.

### DETAILED DESCRIPTION OF THE INVENTION

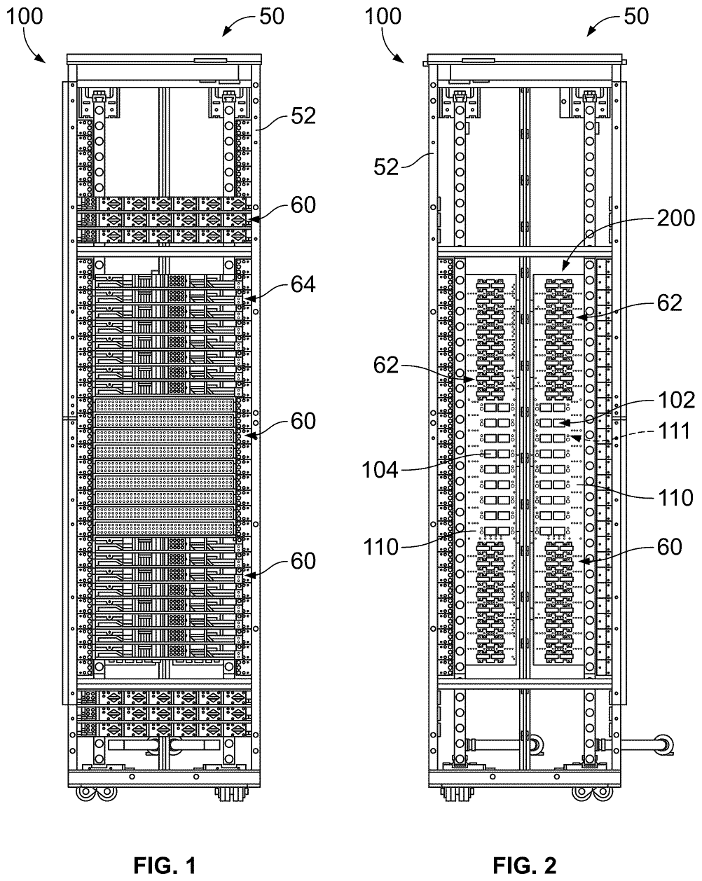

FIG. 1 is a front view of a communication system 100 in accordance with an exemplary embodiment. FIG. 2 is a front view of a portion of the communication system 100 in accordance with an exemplary embodiment. In an exemplary embodiment, the communication system 100 includes a chassis or rack 50 having a rack frame 52 holding electrical components 60. The rack 50 may be a server rack. The electrical components 60 may include fixed modules 62 (FIG. 2) and/or removable modules 64 (FIG. 1). The removable modules 64 may be mated to the fixed modules 62. For example, the removable modules 64 may be plugged into the rack frame 52 and removable from the rack frame 52. In various embodiments, the electrical components 60 may include one or more patch panels, switches, servers, routers, firewalls, and the like. The rack frame 52 may hold a power supply, cooling components, and the like.

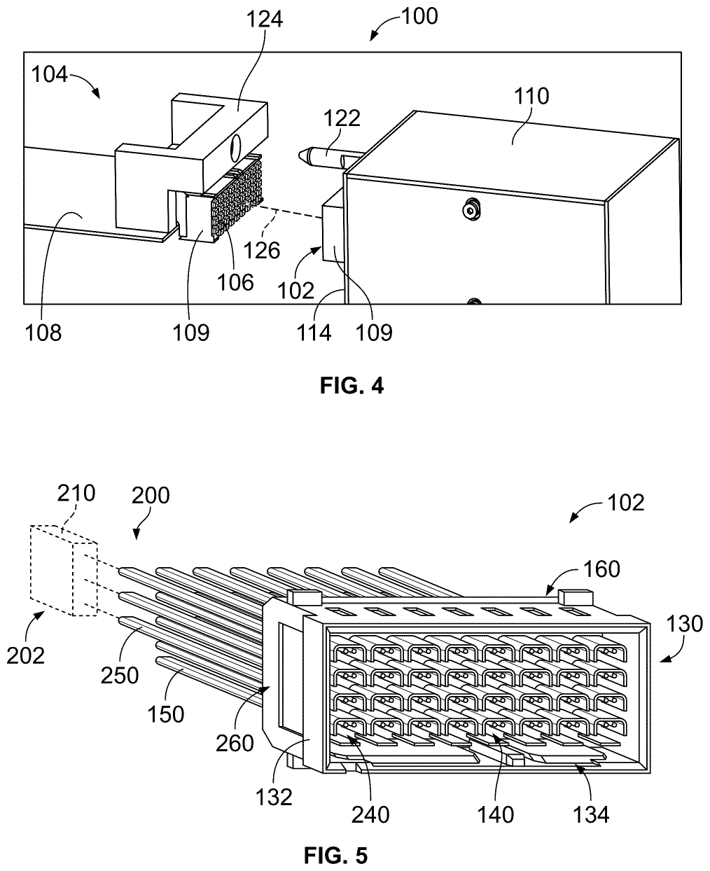

In an exemplary embodiment, the communication system 100 includes at least one connector assembly 102 (FIG. 2) and at least one mating connector assembly 104 (FIG. 4) configured to be mated with the corresponding at least one connector assembly 102. The connector assembly 102 may be part of one of the electrical components 60, such as one of the fixed modules 62. The mating connector assembly 104 may be part of one of the electrical components 60, such as one of the removable modules 64. In various embodiments, each mating connector assembly 104 may include one or more mating electrical connectors mounted to a circuit board, such as a backplane, a daughter card, a network switch, and the like.

In an exemplary embodiment, the communication system 100 includes a connector identification system 200 to identify the various connector assemblies 102 and/or mating connector assemblies 104. The connector identification system 200 may be used to identify physical locations of the connector assemblies 102 within the communication system 100, such as to identify which connector in a cable harness is electrically connected to which electrical component 60 for system management. In an exemplary embodiment, the connector identification system 200 may use identification devices, such as EEPROMs (Electrically Erasable and Programable Read Only Memory), to hold information that allows identification of the various connector assemblies 102. The identification devices may be incorporated with each of the connector assemblies 102. The identification devices may have unique identification information programmed into the identification devices, such as a part number, a program name, a slot ID number, and the like. In an exemplary embodiment, the identification devices are modular and may be incorporated into different types of connector assemblies 102.

In an exemplary embodiment, the communication system 100 includes a cabinet or cartridge 110 that holds the connector assemblies 102. The connector assemblies 102 may be cable connector assemblies having cables extending from corresponding cable connectors. The cartridge 110 may form part of the fixed modules 62. Optionally, multiple cartridges 110 may be provided (for example, left side and right side). The cartridge 110 may be coupled to the rack frame 52, such as at the rear of the rack frame 52. The cartridge 110 forms an enclosed space or chamber 111 for the connector assemblies 102 and the cables of the connector assemblies 102. The cartridge 110 is used for cable management. For example, the cables may be part of cable harnesses routed within the enclosed chamber 111 formed by the cartridge 110 electrically connecting the various connector assemblies 102. The cartridge 110 is used to support or position the connector assemblies 102 for mating with the mating connector assemblies 104.

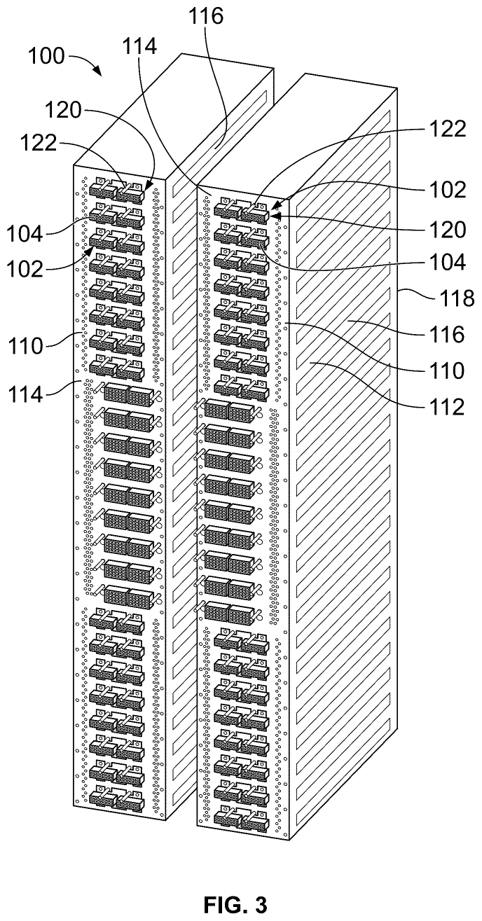

FIG. 3 illustrates a portion of the communication system 100 showing two of the cartridges 110 in accordance with an exemplary embodiment. Each cartridge 110 holds a plurality of the connector assemblies 102, such as in one or more rows and one or more columns. The connector assemblies 102 are provided at the front of the cartridge 110 for interfacing with the mating connector assemblies 104 (shown in FIG. 4).

In an exemplary embodiment, the cartridge 110 is formed from a plurality of panels 112, such as sheet metal panels. The cartridge 110 includes a front panel 114, side panels 116, and a rear panel 118. The panels 112 may additionally include an upper panel and/or a lower panel. The connector assemblies 102 are provided at the front panel 114 for mating with the mating connector assemblies 104. In an exemplary embodiment, the connector assemblies 102 are arranged in a column along the front panel 114. Optionally, the connector assemblies 102 may be provided in multiple columns. The mating ends of the connector assemblies 102 are external to the cartridge 110. For example, the connector assemblies 102 pass through ports or openings 120 in the front panel 114. The connector assemblies 102 are coupled to the front panel 114 adjacent the openings 120. In an exemplary embodiment, the connector assemblies 102 may float or move relative to the front panel 114 to align with and mate to the mating connector assemblies 104. In an exemplary embodiment, the connector assemblies 102 include mating guides, such as guide posts 122, to guide mating of the mating electrical connectors 106 with the connector assemblies 102. The guide posts 122 extend forward of the front panel 114.

FIG. 4 is a perspective view of a portion of the communication system 100 showing one of the mating connector assemblies 104 poised for coupling to the corresponding connector assembly 102. The connector assembly 102 is coupled to the cartridge 110, such as to the front panel 114. In the illustrated embodiment, the mating connector assembly 104 is a network component. For example, the mating connector assembly 104 may be a compute node, a memory module, a network switch, a storage device, a network accelerator, or another type of communication component. The mating connector assembly 104 may be a backplane component or a daughtercard component.

In an exemplary embodiment, the mating connector assembly 104 includes a mating electrical connector 106 mounted to a circuit board 108. The mating connector assembly 104 may be mounted to a front edge of the circuit board 108. The mating electrical connector 106 includes a connector housing 109 holding signal contacts (not shown). The signal contacts are terminated to the circuit board 108. The signal contacts may be socket contacts. The mating electrical connector 106 may includes shields providing shielding for the signal contacts.

The connector assembly 102 is received in the cartridge 110. The connector assembly 102 is provided at the front panel 114 for mating with the mating connector assembly 104 along a mating axis 126. The mating end of the cable connector 130 is configured to pass through an opening in the front panel 114 for mating with the mating electrical connector 106. The connector assemblies 102, 104 are configured to transmit and/or receive data through an interface. The connector assemblies 102 may includes receptacle connectors and the mating connector assemblies 104 may include plug connectors. In an exemplary embodiment, the guide post 122 is configured to be mated with a guide module 124 of the mating connector assembly 104 to guide mating of the mating connector assembly 104 with the connector assembly 102. In the illustrated embodiment, the guide module 124 includes an opening that receives the guide post 122. The mating guides may be used to align the connectors in one or more lateral directions.

FIG. 5 is a front perspective view of one of the connector assemblies 102 in accordance with an exemplary embodiment. In an exemplary embodiment, the connector assembly 102 includes a cable connector 130 having a connector identification module 202. The connector identification module 202 is part of the connector identification system 200 used to identify the connector assembly 102 within the system. In an exemplary embodiment, the connector identification module 202 includes one or more identification contact assemblies 240 and an identification device 210 operably coupled to the identification contact assemblies 240. The identification contact assemblies 240 may be arranged as parts of an identification contact module 260. In an exemplary embodiment, the identification device 210 is connected to the identification contact assemblies 240 by an identification cable 250. For example, the identification device 210 is an EEPROM dongle hanging from the identification contact module 260.

The cable connector 130 includes a connector housing 132 holding the connector identification module 202 and a plurality of contact modules 160. The contact modules 160 include contact assemblies 140 configured to be mated with the mating connector assembly 104. The contact assemblies 140 are terminated to ends of the cables 150. The contact assemblies 140 are arranged together within the contact modules 160. For example, the contact modules 160 hold the contact assemblies 140 in columns. A plurality of the contact modules 160 are received in the connector housing 132, such as being arranged in a contact module stack. In an exemplary embodiment, the connector identification module 202 is arranged in the contact module stack, such as being arranged at one of the ends of the contact module stack. The cables 150 extend from the rear ends of the contact modules 160.

The connector housing 132 includes a cavity 134 that receives the contact modules 160 and the connector identification module 202. The contact assemblies 140 are arranged in the cavity 134 at a mating end for mating with the mating electrical connector 106. For example, the contact assemblies 140 are arranged in the cavity 134 in rows and columns. The cavity 134 may form a receptacle that receives the mating end of the mating electrical connector 106. The walls of the connector housing 132 may be chamfered and have a lead-in surfaces to guide mating of the mating electrical connector 106 in the cavity 134. The connector housing 132 may have guide features to properly position the mating electrical connector 106 within the cavity 134.

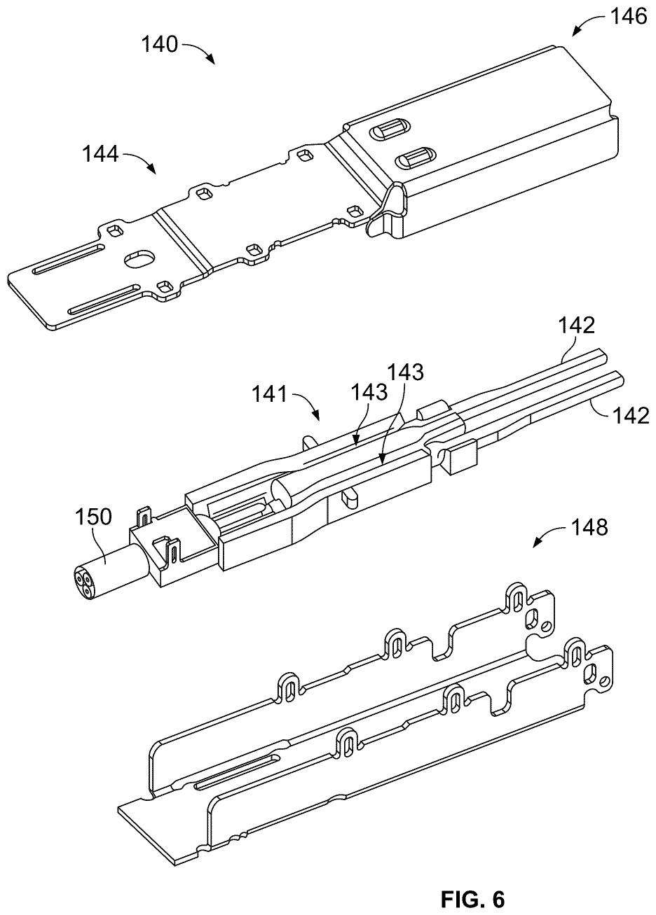

With additional reference to FIG. 6, which is an exploded view of one of the contact assemblies 140, each contact assembly 140 includes at least one signal contact 142, a contact holder 141 holding the at least one signal contact 142, and a shield 144 coupled to the contact holder 141 and providing electrical shielding for the at least one signal contact 142.

In the illustrated embodiment, the contact assembly 140 includes a pair of the signal contacts 142, which define a differential pair. In various embodiments, the signal contacts 142 may be pin contacts. However, in alternative embodiments, the signal contacts 142 may be socket contacts, spring beam contacts, or other types of contacts. The signal contacts 142 may be stamped and formed contacts. Each signal contact 142 is configured to be electrically connected to a corresponding wire or conductor of the cable 150. In an exemplary embodiment, the cable 150 is a twin-axial cable having a first conductor and a second conductor terminated to corresponding signal contacts 142.

The contact holder 141 is manufactured from a dielectric material, such as a plastic material. The contact holder 141 may be molded. The contact holder 141 includes a contact channel 143 for each signal contact 142. In the illustrated embodiment, the contact holder 141 has two contact channels 143 for the pair of signal contacts 142. In various embodiments, the contact holder 141 is preformed and the signal contacts 142 are loaded into the contact holder 141. In other various embodiments, the contact holder 141 is formed in situ around the signal contacts 142, such as being overmolded over the signal contacts 142. The cable 150 may extend into an end of the contact holder 141 to terminate to the signal contacts 142. The contact holder 141 may provide strain relief for the end of the cable 150.

The shield 144 may be a stamped and formed shield. The shield 144 is configured to be coupled to the contact holder 141. The shield 144 may be a multi-piece shield having an upper shield 146 and a lower shield 148. The upper and lower shields 146, 148 are coupled together to provide circumferential shielding for the end of the cable 150 and the signal contacts 142. The shield 144 is configured to be electrically connected to the cable shield of the cable. In an exemplary embodiment, the front end of the shield 144 is C-shaped providing electrical shielding on three sides of the pair of signal contacts 142. The shield 144 may have other shapes in alternative embodiments.

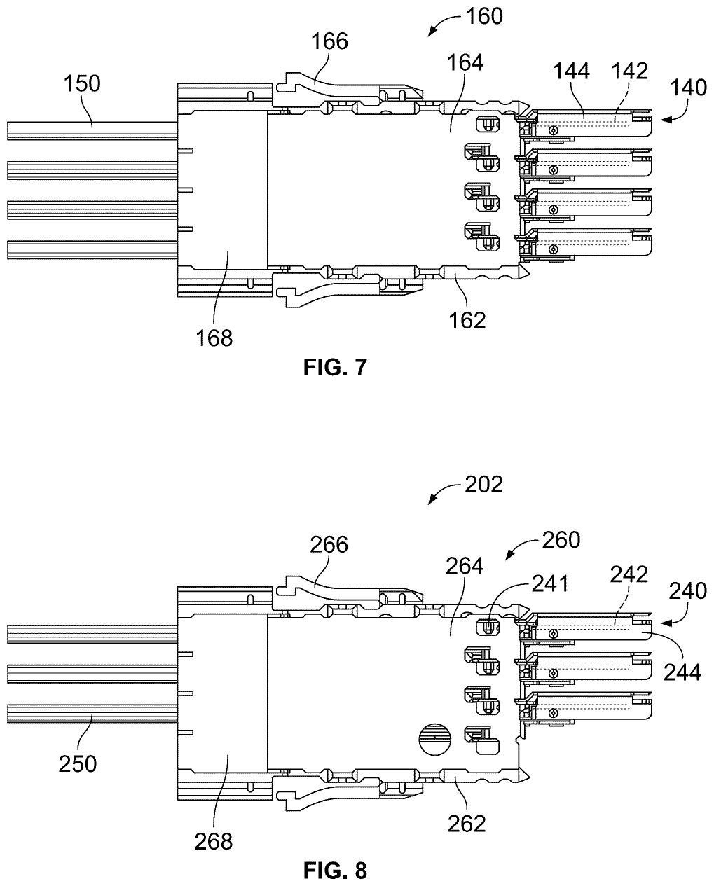

FIG. 7 is a side view of one of the contact modules 160 in accordance with an exemplary embodiment. The contact module 160 includes a body 162 holding the contact assemblies 140. The cables 150 extend from a cable end of the contact module 160. The signal contacts 142 and the shields 144 extend from a mating end of the contact module 160. In an exemplary embodiment, the body 162 holds a ground shield 164 configured to be electrically connected to the shields 144. The body 162 includes latches 166, such as at the top and the bottom of the body 162, used to secure the contact module 160 in the connector housing 132 (shown in FIG. 5). The contact module 160 may include a strain relief 168, such as at the cable end, configured to hold the ends of the cables 150 and provide strain relief for the cables 150. The strain relief 168 may be an overmold overmolded over the ends of the cables 150.

FIG. 8 is a side view of a portion of the connector identification module 202 showing an identification contact module 260 in accordance with an exemplary embodiment. The identification contact module 260 may be similar to the signal contact module 160 (shown in FIG. 7). For example, the identification contact module 260 and the contact module 160 may have similar dimensions and components. The identification contact module 260 and the contact module 160 may be interchangeable within the contact module stack and arranged in the connector housing 132 for mating with the mating connector assembly 104. In an exemplary embodiment, the identification contact module 260 includes a plurality of the contact assemblies 240 configured to be mated with the mating connector assembly 104.

The identification contact module 260 includes a body 262 holding the identification contact assemblies 240. The identification cables 250 extend from a cable end of the identification contact module 260. The identification contact assemblies 240 may be similar to the contact assembly 140 (shown in FIG. 6). Each identification contact assembly 240 includes at least one identification signal contact 242, a contact holder 241 holding the at least one identification signal contact 242 in contact channels, and a shield 244 coupled to the contact holder 241 and providing electrical shielding for the at least one identification signal contact 242. In an exemplary embodiment, the identification contact assembly 240 includes a pair of the identification signal contacts 242, which define a differential pair. Each identification signal contact 242 is configured to be electrically connected to a corresponding wire or conductor of the identification cable 250. In an exemplary embodiment, the identification cable 250 is a twin-axial cable having a first conductor and a second conductor terminated to corresponding identification signal contacts 242. The shield 244 is configured to be electrically connected to the cable shield of the cable. In an exemplary embodiment, the front end of the shield 244 is C-shaped providing electrical shielding on three sides of the pair of signal contacts 242.

The identification signal contacts 242 and the shields 244 extend from a mating end of the identification contact module 260. In an exemplary embodiment, the body 262 holds a ground shield 264 configured to be electrically connected to the shields 244. The body 262 includes latches 266, such as at the top and the bottom of the body 262, used to secure the identification contact module 260 in the connector housing 132 (shown in FIG. 5). The identification contact module 260 may include a strain relief 268, such as at the cable end, configured to hold the ends of the identification cables 250 and provide strain relief for the identification cables 250. The strain relief 268 may be an overmold overmolded over the ends of the identification cables 250. In the illustrated embodiment, the identification contact module 260 includes three of the identification contact assemblies 240, which may correspond to hot, ground, and neutral for the connector identification module 202.

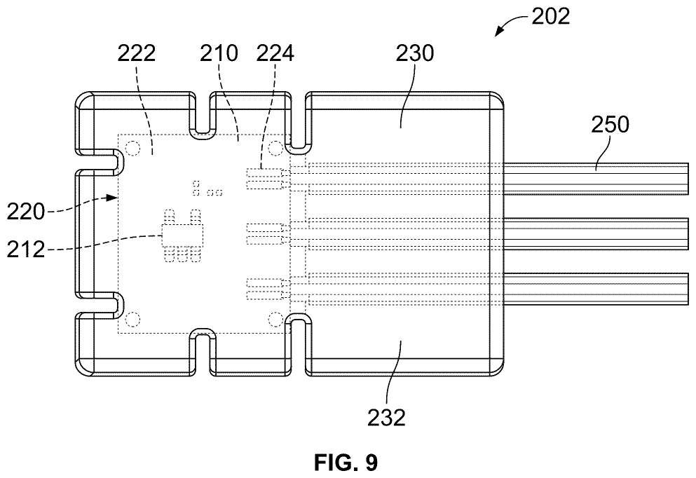

FIG. 9 is a side view of a portion of the connector identification module 202 showing the identification device 210 in accordance with an exemplary embodiment. The identification device 210 is provided at ends of the identification cables 250 opposite the identification contact module 260 (shown in FIG. 8). The identification device 210 is used to identify the connector assembly 102 associated with the connector identification module 202. The identification device 210 may be used to identify physical locations of the connector assembly 102 within the communication system 100. In an exemplary embodiment, the identification device 210 may be an EEPROM. The identification device 210 holds information that allows identification of the connector assembly 102. The identification device 210 may have unique identification information programmed into the identification device 210, such as a part number, a program name, a slot ID number, and the like. The identification device 210 is operably coupled to the identification signal contacts 244 to transmit the unique identification data to the mating connector assembly 104.

In an exemplary embodiment, the identification device 210 includes an electronic device 212 that stores unique identification data. The electronic device 212 may be an integrated circuit, such as a chip. In an exemplary embodiment, the electronic device 212 is an EEPROM chip. The electronic device 212 is programmable to store the identification data, such as a part number, a program name, a slot ID number, and the like.

In an exemplary embodiment, the identification device 210 includes a printed circuit board assembly 220 including a printed circuit board 222, the electronic device 212 mounted to the printed circuit board 222 and may include other components mounted to the printed circuit board 222. The printed circuit board 222 includes pads 224 on one or more surfaces of the printed circuit board 222. The identification cables 250 are terminated to the pads 224, such as being soldered to the pads 224.

In an exemplary embodiment, the identification device 210 includes a device shell 230 holding the printed circuit board assembly 220. The device shell 230 surrounds the printed circuit board 222 and the electronic device 212. In an exemplary embodiment, the device shell 230 includes an overmold body 232 overmolded over the printed circuit board assembly 220. In alternative embodiments, the device shell 230 may include shells coupled together to hold the printed circuit board assembly 220 therebetween. The device shell 230 surrounds the printed circuit board assembly 220 to protect the components, such as the electronic device 212. In an exemplary embodiment, the device shell 230 holds the identification cables 250. For example, the overmold body 232 may be overmolded over the ends of the identification cables 250. The device shell 230 may provide strain relief for the identification cables 250.

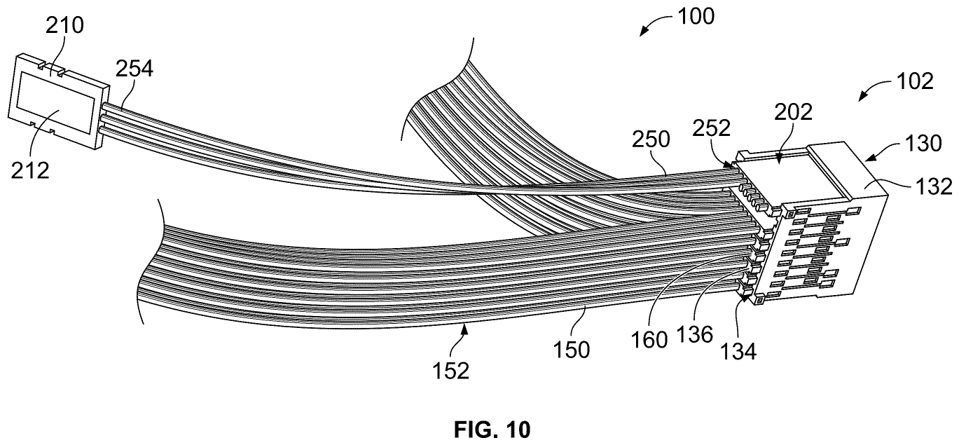

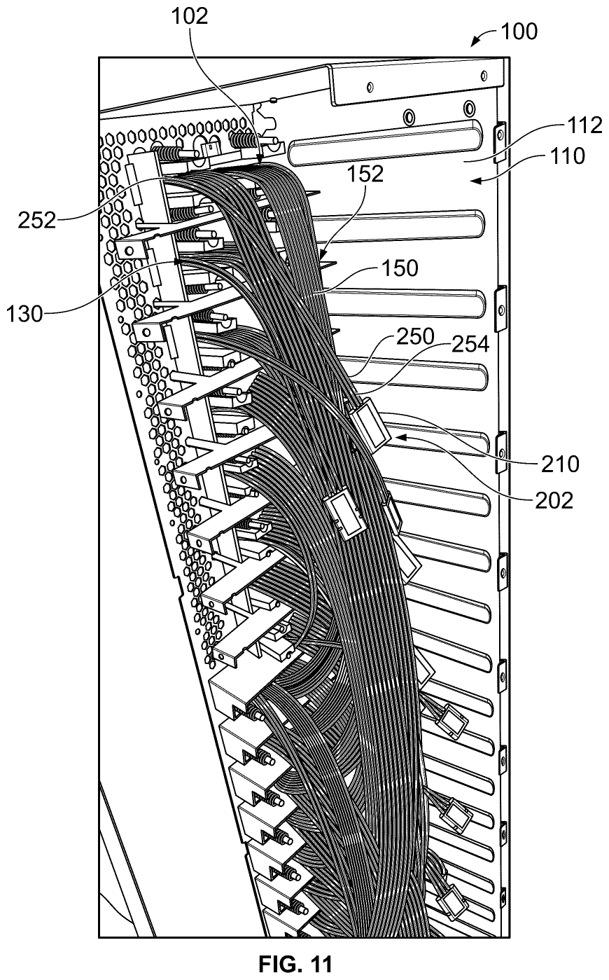

FIG. 10 illustrates one of the connector assemblies 102 in accordance with an exemplary embodiment having the connector identification module 202. FIG. 11 illustrates a portion of the communication system 100 showing a plurality of the connector assemblies 102 in accordance with an exemplary embodiment arranged in the cartridge 110. Some of the panels 112 of the cartridge 110 are removed to illustrate the connector assemblies 102, the cables 150 between the connector assemblies 102, and the connector identification modules 202 associated with each of the connector assemblies 102. The cables 150 are part of cable harnesses 152 that connect the various connector assemblies 102. The cable harnesses 152 are contained in the cartridge 110, such as in the enclosed chamber 111 defined by the panels 112.

When assembled, the connector identification module 202 and the contact modules 160 are loaded into the connector housing 132. For example, the connector identification module 202 and the contact modules 160 are arranged in the cavity 134. The connector identification module 202 and the contact modules 160 may be received in contact assembly slots 136 in the cavity 134. The connector identification module 202 and the contact modules 160 may be interchangeably receivable in the contact assembly slots 136. For example, because the connector identification module 202 and the contact modules 160 have the same dimensions and mating features, the connector identification module 202 may be arranged in any of the slots.

The cables 150 extend from the cable side of the cable connector 130, such as to another cable connector 130. The identification cables 250 extend from the cable side of the cable connector 130 to allow the identification device 210 to dangle or hang from the cable connector 130. For example, the identification device 210 may be an EEPROM dongle hanging from the cable connector 130. The identification device 210 is remote from the connector housing 132. For example, the identification cables 250 have sufficient length to allow the identification device 210 to hang in the enclosed chamber 111 spaced apart from the connector housing 132. In an exemplary embodiment, a first end 252 of each identification cable 250 is terminated to the identification signal contact 242 of the identification contact assembly 240. A second end 254 of each identification cable 250 is terminated to the identification device 210, such as to the printed circuit board 222. The identification cables 250 define data channels between the electronic device 212 on the printed circuit board 222 and the identification signal contacts 244 to transmit the unique identification data to the mating connector assembly.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A cable connector assembly comprising:
a cable connector including a connector housing having walls defining a cavity, the cable connector including contact assemblies received in the cavity, each contact assembly including a contact holder holding a signal contact and a shield providing shielding for the signal contact, the signal contacts and the shields of the contact assemblies arranged at a mating end of the cable connector configured to be mated with a mating connector assembly;
cables terminated to the signal contacts and extending from a cable end of the cable connector, the cables defining data channels; and
a connector identification module configured to be mated with the mating connector assembly, the connector identification module including an identification contact assembly received in the cavity and coupled to the connector housing, the identification contact assembly including an identification contact holder holding an identification signal contact arranged at the mating end of the cable connector configured to be mated with the mating connector assembly, the connector identification module including an identification device having unique identification data stored on the identification device, the identification device being operably coupled to the identification signal contact to transmit the unique identification data to the mating connector assembly.

2. The cable connector assembly of claim 1, wherein the connector identification module includes an identification cable between the identification contact assembly and the identification device.

3. The cable connector assembly of claim 1, wherein the identification device is remote from the connector housing, the identification device being connected to the identification contact assembly by an identification cable.

4. The cable connector assembly of claim 1, wherein the connector identification module includes an identification cable extending between a first end and a second end, the first end being terminated to the identification signal contact, the second end being terminated to the identification device.

5. The cable connector assembly of claim 5, wherein the identification device includes a printed circuit board assembly including a printed circuit board and an electronic device mounted to the printed circuit board, the unique identification data being stored on the electronic device, wherein the second end of the identification cable is terminated to the printed circuit board, the identification cable defining a data channel between the printed circuit board and the identification signal contact to transmit the unique identification data to the mating connector assembly.

6. The cable connector assembly of claim 5, wherein the identification device is an EEPROM dongle hanging from the identification contact assembly.

7. The cable connector assembly of claim 5, wherein the identification device includes a device shell surrounding the printed circuit board assembly.

8. The cable connector assembly of claim 7, wherein the device shell includes an overmold body overmolded over the printed circuit board, the electronic device, and the second end of the identification cable.

9. The cable connector assembly of claim 5, wherein the electronic device includes an EEPROM chip.

10. The cable connector assembly of claim 5, wherein the identification cable is a first identification cable, the connector identification module further comprising a second identification cable terminated to the printed circuit board and a second identification signal contact and a third identification cable terminated to the printed circuit board and a third identification signal contact.

11. The cable connector assembly of claim 5, wherein the identification cable is a twinaxial cable having a first conductor and a second conductor, the first conductor terminated to the identification signal contact, the second conductor terminated to a second identification signal contact of the identification contact assembly.

12. The cable connector assembly of claim 5, wherein the identification contact assembly includes a shield providing shielding for the identification signal contact, the shield being electrically connected to a cable shield of the identification cable.

13. The cable connector assembly of claim 1, wherein the connector housing includes contact assembly slots in the cavity, the contact assemblies and the identification contact assembly being interchangeably receivable in the contact assembly slots.

14. The cable connector assembly of claim 1, wherein the identification contact assembly is sized and shaped the same as the contact assemblies of the cable connector.

15. The cable connector assembly of claim 1, wherein each contact assembly includes latches being latchably coupled to the connector housing to secure the contact assembly in the cavity, the identification contact assembly including latches being latchably coupled to the connector housing to secure the identification contact assembly in the cavity.

16. A connector identification module comprising:
an identification contact assembly includes an identification contact holder extending between a front and a rear, the identification contact assembly including an identification signal contact held by the identification contact holder, the identification signal contact including a mating end and a terminating end, the mating end configured to be mated with a mating connector assembly;
an identification cable extending between a first end and a second end, the first end terminated to the identification signal contact; and
an identification device having a printed circuit board assembly including a printed circuit board and an electronic device mounted to the printed circuit, the electronic device having unique identification data stored on the electronic device, the printed circuit board being terminated to the second end of the identification cable, wherein the cable defines a data channel between the printed circuit board and the identification signal contact to transmit the unique identification data to the mating connector assembly.

17. The connector identification module of claim 16, wherein the identification device is an EEPROM dongle hanging from the identification contact assembly.

18. The connector identification module of claim 16, wherein the identification device includes a device shell surrounding the printed circuit board assembly.

19. A communication system comprising:
a cartridge having panels forming a chamber, the cartridge including ports at a front of the cartridge;
cable connector assemblies received in the ports for mating with mating connector assemblies, each cable connector assembly including a cable connector and a connector identification module communicatively coupled to the cable connector by cables,
each cable connector including a connector housing having walls defining a cavity, the cable connector including contact assemblies received in the cavity, each contact assembly including a contact holder holding a signal contact and a shield providing shielding for the signal contact, the signal contacts and the shields of the contact assemblies arranged at a mating end of the cable connector configured to be mated with the mating connector assembly;
the cables terminated to the signal contacts and extending from a cable end of the cable connector, the cables defining data channels; and
the connector identification module including an identification contact assembly received in the cavity and coupled to the connector housing, the identification contact assembly including an identification contact holder holding an identification signal contacts arranged at the mating end of the cable connector configured to be mated with the mating connector assembly, the connector identification module including an identification device having unique identification data stored on the identification device, the identification device being operably coupled to the identification signal contacts to transmit the unique identification data to the mating connector assembly.

20. The communication system of claim 19, wherein the connector identification modules uniquely identify the positions of the corresponding cable connector assemblies within the communication system based on the unique identification data.
